(19) United States
(12) Patent Application Publication
(10) Pub. No.: US 2013/0344705 A1
(43) Pub. Date: Dec. 26, 2013

(54) ELECTRICAL CONNECTOR

(71) Applicant: Igor Mikhnenko, Kharkov (UA)

(72) Inventor: Igor Mikhnenko, Kharkov (UA)

(21) Appl. No.: 13/876,435

(22) PCT Filed: Sep. 13, 2011
(86) PCT No.: PCT/UA2011/000085

§ 371 Date: Sep. 9, 2013

(30) Foreign Application Priority Data
Sep. 28, 2010 (GB) 1016288.1
Sep. 28, 2010 (GB) 1016289.9
Oct. 20, 2010 (GB) 1017776.4
Dec. 10, 2010 (GB) 1020999.7
Aug. 18, 2011 (GB) 1114250.2

(51) Int. Cl. H01R 35/04

(52) U.S. Cl. CPC H01R 35/04
USPC 439/13

(57) ABSTRACT

The field of the invention is electrical connectors, and devices including electrical connectors. There is provided an electrical connector composite comprising a first electrical connector and a second electrical connector, the electrical connector composite mountable in a device and providing an electrical connection to the device, the electrical connector composite rotatable with respect to the device when mounted in the device, the electrical connector composite rotatable to present the first electrical connector in an electrically connectable configuration, and the electrical connector composite rotatable to present the second electrical connector in an electrically connectable configuration.

### BACKGROUND OF THE INVENTION

1. Field of the Invention

The field of the invention is electrical connectors, and devices including electrical connectors.

2. Technical Background

Prior art universal serial bus (USB) connectors are shown in prior art FIG. 1. A primer on USB technology is provided in Appendix 1.

3. Discussion of Related Art

Utility model CN2857279Y discloses a structure of a rotatable universal serial bus connector, as shown in prior art FIG. 11, wherein a first signal contact region is disposed in the USB slot on the main surface of the universal serial bus connector. The first signal contact region extends to a surface of the USB connector to form a second signal contact region. Adjacent the second signal contact region provided is a center shaft on the other surface. The USB connector main body is rotatably disposed in an accomodating base with a certain angle. The accomodating base consists of a bottom and a side wall extending towards one direction along the bottom, wherein the bottom is provided with a third signal contact region corresponding to the trace of the second signal contact region. The third signal contact region extends to the periphery of the bottom to form a fourth signal contact region which can be disposed on the main board of the electronic product. By regulating the rotating angle, USB plugs of different sizes pertaining to peripheral equipment are conveniently inserted into slots.

### SUMMARY OF THE INVENTION

According to a first aspect of the invention, there is provided an electrical connector composite comprising a first electrical connector and a second electrical connector, the electrical connector composite mountable in a device and providing an electrical connection to the device, the electrical connector composite rotatable with respect to the device when mounted in the device, the electrical connector composite rotatable to present the first electrical connector in an electrically connectable configuration, and the electrical connector composite rotatable to present the second electrical connector in an electrically connectable configuration.

The electrical connector composite may be one wherein the electrical connector composite is built into the device.

The electrical connector composite may be one wherein leads from the first electrical connector are electrically connected to leads in common from the second electrical connector.

The electrical connector composite may be one wherein the electrical connector composite includes a flexible material.

The electrical connector composite may be one wherein the flexible material is fully self-supporting.

The electrical connector composite may be one wherein the flexible material is partially self-supporting.

The electrical connector composite may be one wherein the electrical connector composite includes a flexible portion situated between the first electrical connector and the second electrical connector.

The electrical connector composite may be one wherein the electrical connector composite is substantially composed of flexible material.

The electrical connector composite may be one wherein the first electrical connector is substantially composed of flexible material.

The electrical connector composite may be one wherein the second electrical connector is substantially composed of flexible material.

The electrical connector composite may be one wherein the first electrical connector is substantially composed of rigid material.

The electrical connector composite may be one wherein the second electrical connector is substantially composed of rigid material.

The electrical connector composite may be one wherein the first electrical connector and the second electrical connector have a relative orientation of 180 degrees within the electrical connector composite.

The electrical connector composite may be one wherein the first electrical connector and the second electrical connector are respectively presented for electrical connection upon rotation of the electrical connector composite by 180 degrees.

The electrical connector composite may be one wherein the first electrical connector and the second electrical connector are situated on opposite sides of the electrical connector composite.

The electrical connector composite may be one wherein the first electrical connector and the second electrical connector have a relative orientation of 90 degrees within the electrical connector composite.

The electrical connector composite may be one wherein when the second electrical connector is presented for electrical connection, the first electrical connector adopts a general profile of the device.

The electrical connector composite may be one wherein the electrical connector composite is rotatable to present the first electrical connector in a non-electrically connectable configuration, and the electrical connector composite is rotatable to present the second electrical connector in a non-electrically connectable configuration.

The electrical connector composite may be one wherein the first electrical connector and second electrical connector cannot be used simultaneously because of a hinged arrangement of the electrical connector composite.

The electrical connector composite may be one wherein the electrical connector composite is in swivelling attachment with the device.

The electrical connector composite may be one wherein one of the first electrical connector and the second electrical connector is a USB connector.

The electrical connector composite may be one wherein the first electrical connector and the second electrical connector are USB connectors.

The electrical connector composite may be one wherein the first electrical connector and the second electrical connector are differing USB connectors.

The electrical connector composite may be one wherein the first electrical connector is a male connector and the second electrical connector is a female connector.

The electrical connector composite may be one wherein the first electrical connector is a type A male connector.

The electrical connector composite may be one wherein the second electrical connector is a Micro A, Micro B or Type A female connector.

The electrical connector composite may be one wherein the first electrical connector and the second electrical connector are a Type A connector and one of a USB Mini A, Micro A, Mini B, or Micro B connector, respectively.

The electrical connector composite may be one wherein the electrical connector composite can be rotated to present one USB connector or the other USB connector, for a user to plug into.

According to a second aspect of the invention there is provided a device into which the electrical connector composite of any of the above sentences within this Summary of the Invention section is built-in.

The device may be a mobile device.

The mobile device may be a mobile phone, a laptop computer, a tablet computer (eg. ipad), a portable digital assistant, a digital audio player (eg. ipod), an iPhone, an iPad, or a bar form factor portable device.

The mobile device may be a bar form factor display device comprising front and back major faces, the front major face arranged to present a first display screen and the back major face arranged to present a second display screen different to the first display screen.

The bar form factor display device may be one in which the second display screen is a bi-stable display screen.

The bar form factor display device may be one in which the first display screen is a liquid crystal display screen.

The bar form factor display device may include a concave front face and a convex rear face.

### BRIEF DESCRIPTION OF THE DRAWINGS

FIG. 1 shows USB connectors of the prior art.

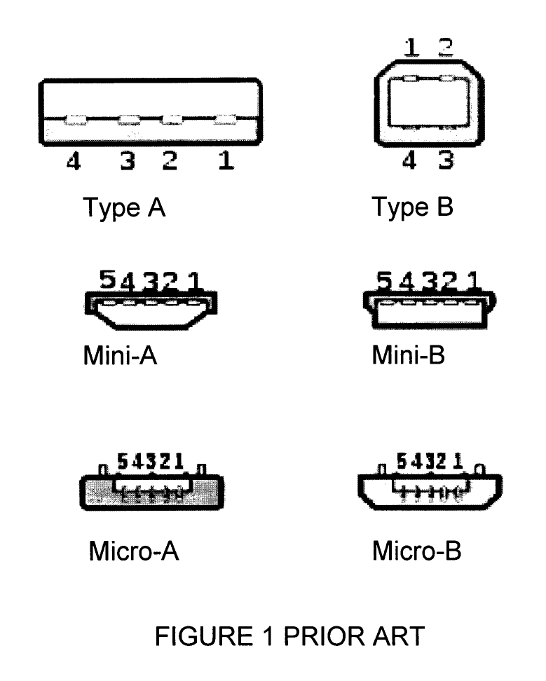

FIG. 2 shows a perspective view of a type A male connector part of a rotatable connector composite presented on the side of a device.

FIG. 3 shows a plan view of the type A male connector part of a rotatable connector composite of FIG. 2.

FIG. 4 shows a perspective view of a type A male connector of a rotatable connector composite presented on the side of a device.

FIG. 5 shows a perspective view of a second configuration of the rotatable connector composite shown in a first configuration in FIG. 4.

FIG. 6 shows a side view of the second configuration of the rotatable connector composite shown in FIG. 5.

FIG. 7 shows a Table which provides USB 1.x/2.0 standard pinning of the prior art.

FIG. 8 shows a Table which provides USB 1.x/2.0 Mini/Micro pinning of the prior art.

FIG. 9 shows a Table which provides Host Interface receptacles (USB 1.x/2.0) of the prior art. The receptacles shown accept or do not accept the plugs as indicated in the Table.

FIG. 10 shows a Table which provides Cable plugs (USB 1.x/2.0) of the prior art. The cables exist with pairs of plugs as indicated in the Table.

FIG. 11 shows a rotatable USB connector of the prior art.

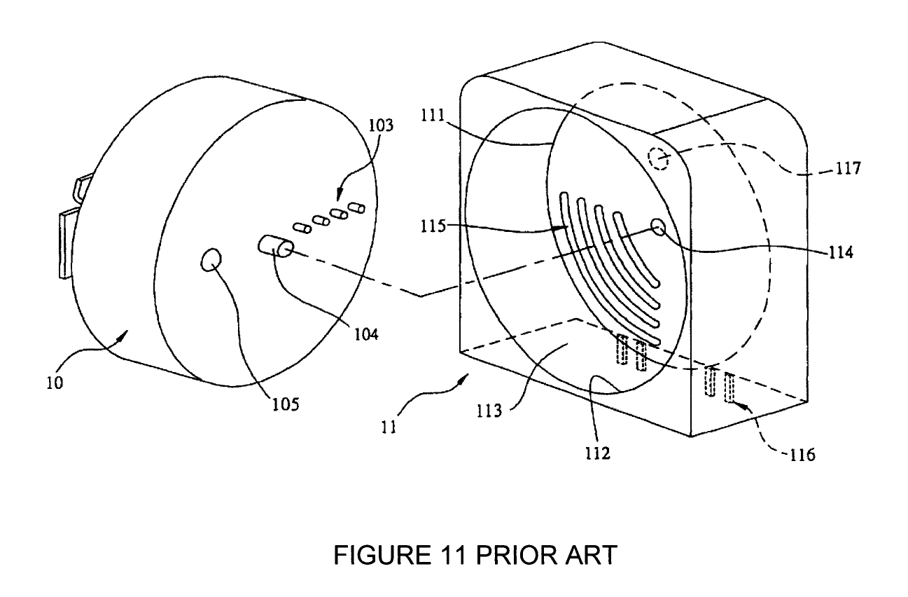

FIG. 12 shows a side view of a rotatable connector composite comprising a type A male connector part, a female connector part (not shown) and a flexible portion between the type A male connector part and the female connector part (not shown). In this Figure, the flexible portion is fully self-supporting.

FIG. 13 shows a side view of a rotatable connector composite comprising a type A male connector part, a female connector part (not shown) and a flexible portion between the type A male connector part and the female connector part (not shown). Compared to FIG. 12, here the flexible portion has been flexed under gravity (acting downwards in this Figure) so that the type A male connector part is pointing down. In this Figure, the flexible portion is partially self-supporting.

FIG. 14 shows the front face and back face of an example device of an aspect of the invention in the same Figure. The device is shown in the off state.

FIG. 15 shows the front face and the back face of an example device of an aspect of the invention in the same Figure. The device is shown in the on state.

FIG. 16 shows a side view of an example device of an aspect of the invention. The device may relate to the device of FIG. 15.

FIG. 17 shows the front face and the back face of an example device of an aspect of the invention in the same Figure. The device is shown in the on state. The device may relate to the device of FIG. 15.

### DETAILED DESCRIPTION

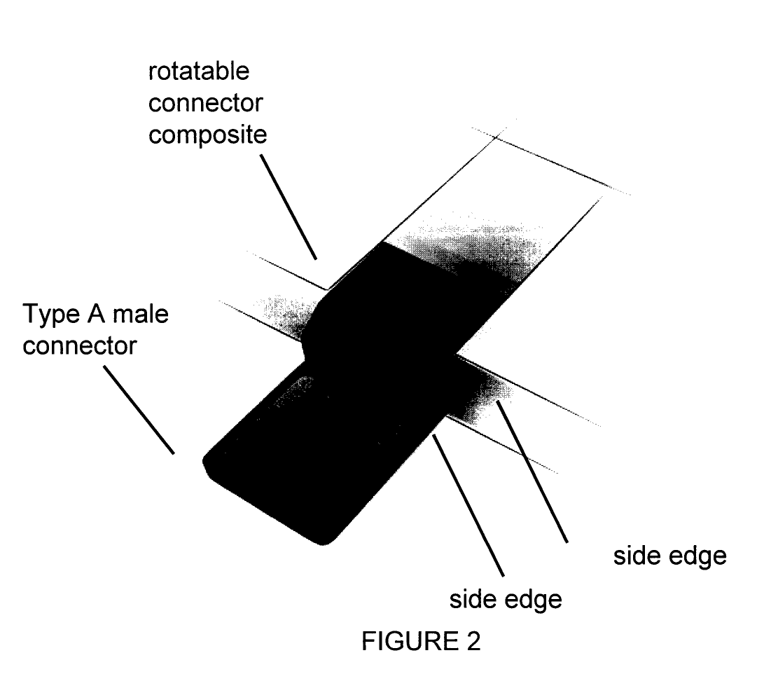

An example of the invention is to combine a USB Type A connector and one of the USB Mini A, Micro A, Mini B, or Micro B connectors. For example, this may be very convenient for mobile device users—they can connect a device with a Type A cable, Mini A or B cable, Micro A or B cable or directly with Type A plug. Examples of such connectors are shown in FIGS. 2 to 6.

An example of the invention is to combine two different types of USB connectors (eg. Type A plus one of Mini A, Mini B, Micro A, Micro B) into a single receptacle. As shown for example in FIGS. 2 to 6, the receptacle is built into a device and can be rotated to present one USB connector or the other, for the user to plug into. According to one example, the receptacle will have the type A (Father) and micro A or B (mother) connectors.

Here is an advantage over a conventional arrangement in, say, a laptop in which you have USB Type A socket, plus a Mini A socket next to it. All USB devices are divided into two groups—masters (laptops, PC's and so on) and slaves (peripheral devices: modems, USB-sticks, mobile phones). In one example, there is provided a type A connector (Father, used for slave devices), so you can plug-in a device directly to your PC, and a type micro A or B connector (Mother, you can plug in a device to your laptop with a cable which has on the end of it a Type micro A or B connector Father. The Mother micro A or B connector could also be a Mother Type A connector, so you could plug in a device to your laptop with a cable which has on the end of it a Type A connector Father.

With regard to how the electrical leads are taken out of the combined, swivelling receptacle, the leads from the USB Type A connector may be bonded to the leads in common from the other type of connector. In one example, you can't use two connectors simultaneously because of the hinge.

In addition to the hinged, swivelling connector, there are other ways one can combine two or more USB type connectors into the same receptacle. In one example, a micro A or B connector can be rotated by 90 degrees from original location: Type A and type Micro A or B connectors will have 90 degree angle in between in this example.

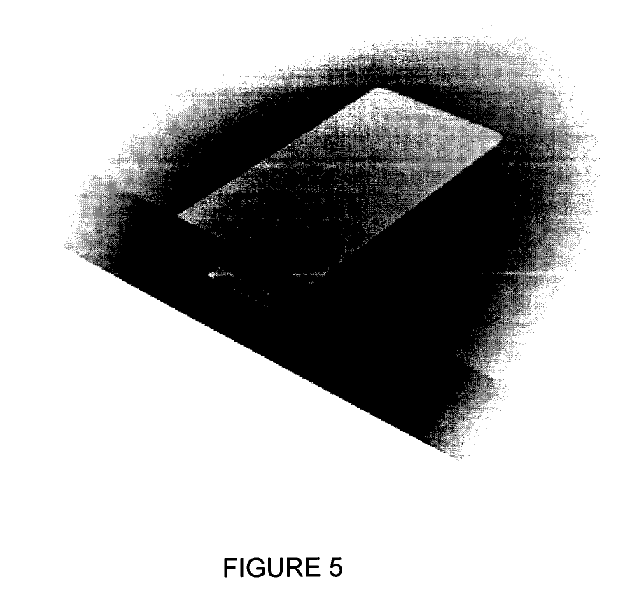

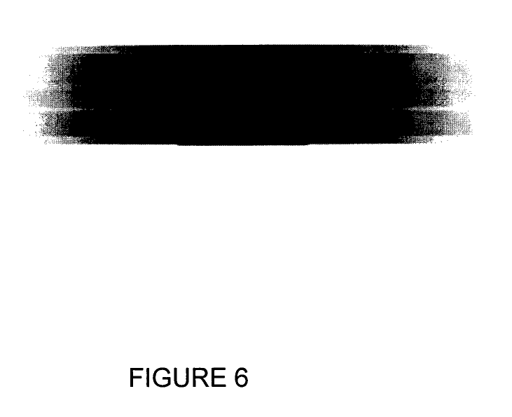

FIG. 2 shows a perspective view of a type A male connector presented on the side of a device. In FIG. 2, the type A male connector is presented in a first configuration of a rotatable connector composite in which the type A male connector is presented on the side of a larger device. In a second configuration, for example, the rotatable connector composite is rotated (eg. 180 degrees with respect to the first configuration around an axis parallel to either of the side edges of the device shown in FIG. 2) such that the side of the device presents a female connector such as a mini A, mini B, micro A or micro B connector, and the type A male connector is not presented, but instead adopts the general profile of the device, such as shown for example for the connector composite of FIGS. 5 and 6.

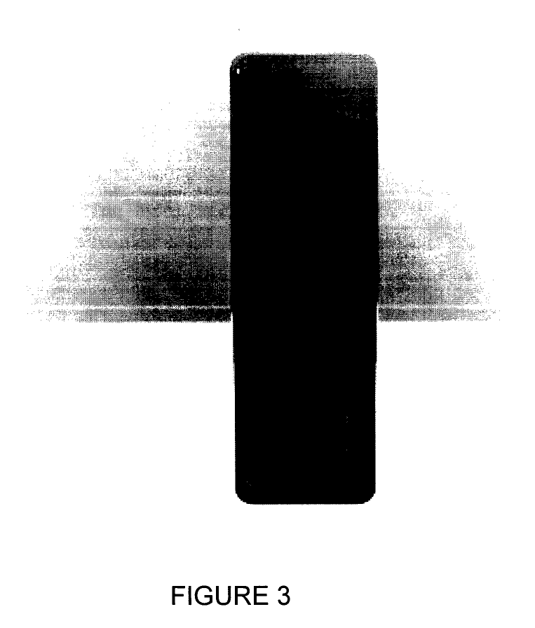

FIG. 3 shows a plan view of the type A male connector of FIG. 2.

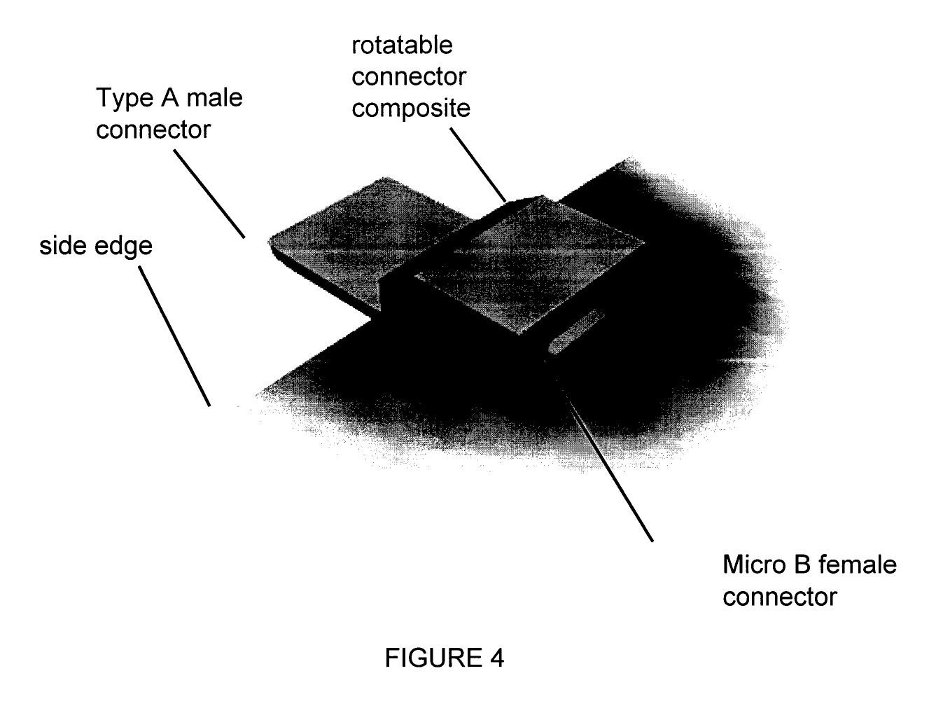

FIG. 4 shows a perspective view of a type A male connector presented on the side of a device. In FIG. 4, the type A male connector is presented in a first configuration of a rotatable connector composite in which the type A male connector is presented on the side of a larger device. On the opposite side of the rotatable connector composite to the type A male connector, there is presented a micro B female connector. In a second configuration, for example, the rotatable connector composite is rotated (eg. 180 degrees with respect to the first configuration around an axis parallel to a side edge of the device shown in FIG. 4) such that the side of the device presents a female micro B connector, and the type A male connector is not presented, but instead adopts the general profile of the device, such as shown for example in FIGS. 5 and 6.

FIG. 5 shows a perspective view of a second configuration of the rotatable connector composite shown in a first configuration in FIG. 4. FIG. 6 shows a side view of the second configuration of the rotatable connector composite shown in FIG. 5.

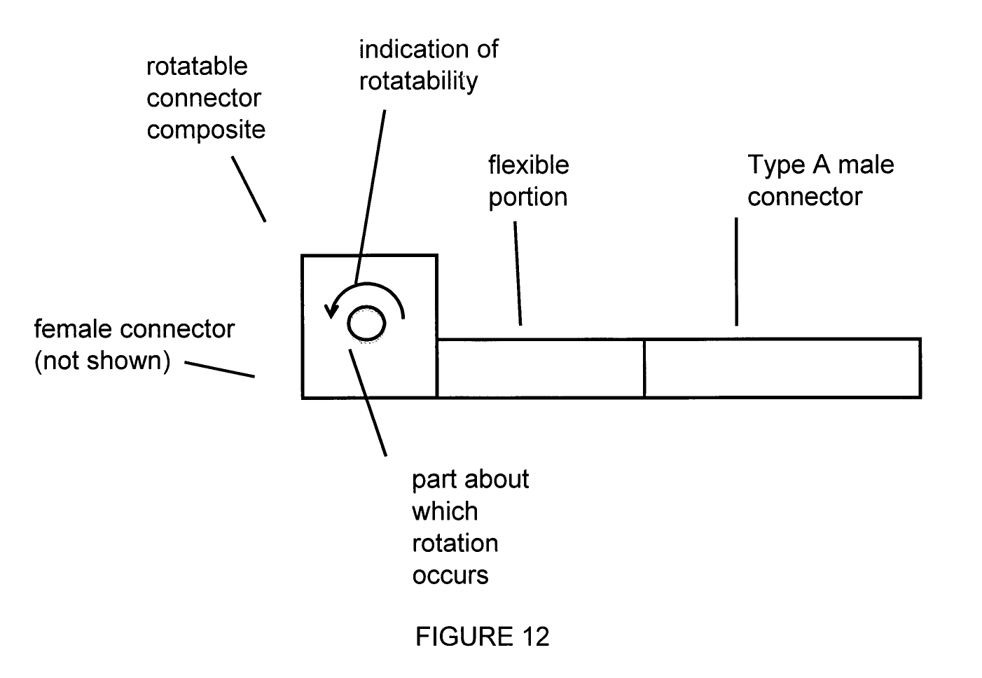

FIG. 12 shows a side view of a rotatable connector composite including a type A male connector, a flexible portion, and a female connector (not shown). In FIG. 12, the type A male connector is presented in a first configuration of a rotatable connector composite in which the type A male connector is presented on the side of a larger device. In a second configuration, for example, the rotatable connector composite is rotated (eg. 180 degrees with respect to the first configuration around an axis perpendicular to the page containing FIG. 12 eg. the axis passing through the circular part shown in the Figure) such that the side of the device presents a female connector such as a mini A, mini B, micro A or micro B connector, and the type A male connector is not presented, but instead adopts the general profile of the device, such as shown for example for the connector composite of FIGS. 5 and 6.

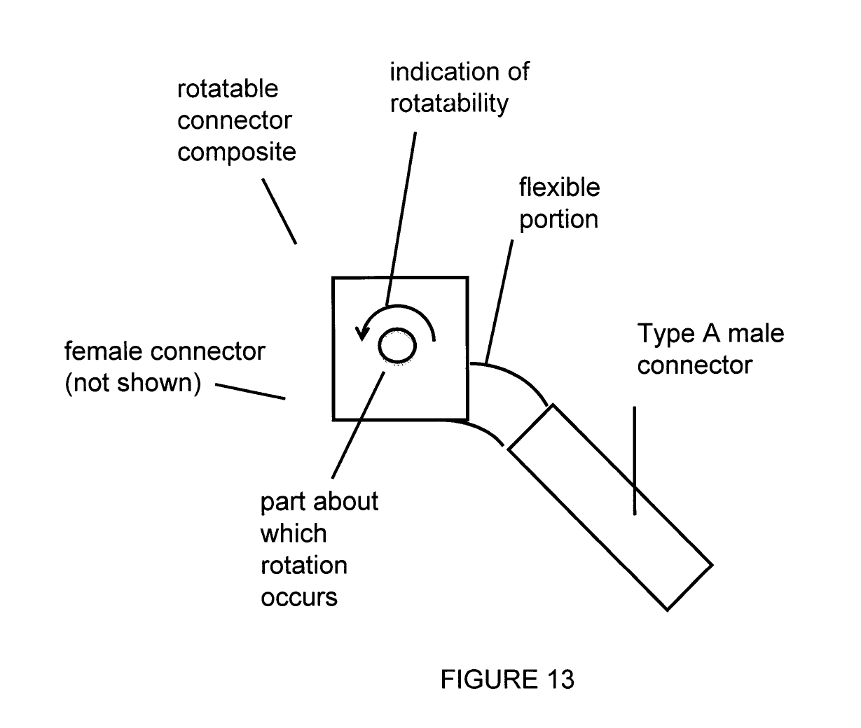

FIG. 13 shows a side view of a rotatable connector composite including a type A male connector, a flexible portion, and a female connector (not shown). In FIG. 13, the type A male connector is presented in a first configuration of a rotatable connector composite in which the type A male connector is presented on the side of a larger device. In a second configuration, for example, the rotatable connector composite is rotated (eg. 180 degrees with respect to the first configuration around an axis perpendicular to the page containing FIG. 13 eg. the axis passing through the circular part shown in the Figure) such that the side of the device presents a female connector such as a mini A, mini B, micro A or micro B connector, and the type A male connector is not presented, but instead adopts the general profile of the device, such as shown for example for the connector composite of FIGS. 5 and 6. Compared to FIG. 12, in FIG. 13 the flexible portion has been flexed so that the type A male connector part is pointing down.

It will be appreciated by those skilled in the art that the flexible portion of the connector composite shown in FIGS. 12 and 13 does not have to be limited to a section between the type A male connector and the female connector, but can extend more generally through the connector composite. For example, the connector composite can be made substantially of flexible material eg. a rubber-like material, although the USB connectors themselves may or may not be made of flexible material. For example, one or more of the USB connectors may be made of rigid material.

It will be appreciated by those skilled in the art that the flexible material may be fully self-supporting, or may be at least partially self-supporting.

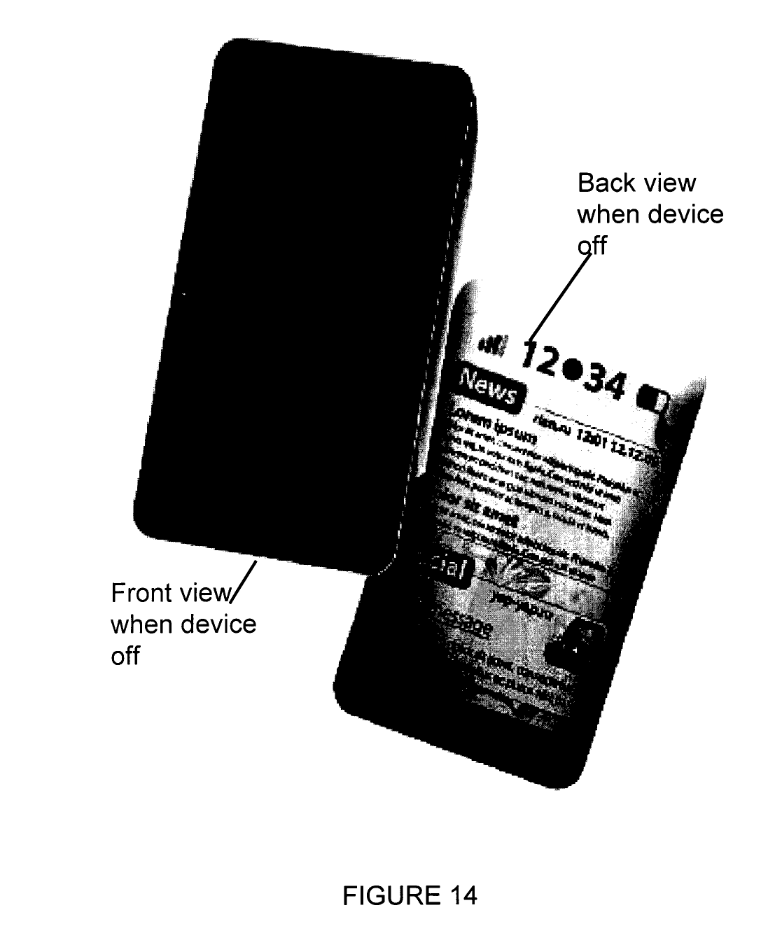

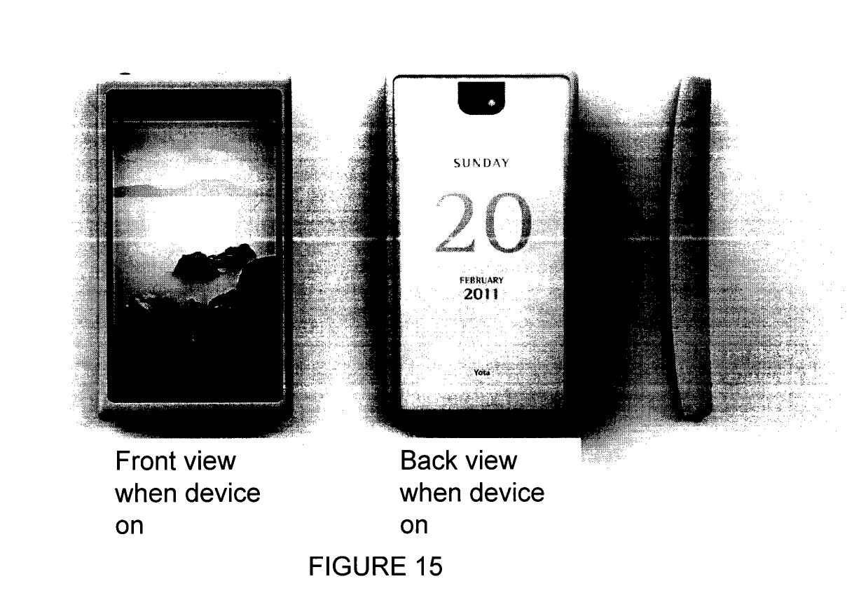

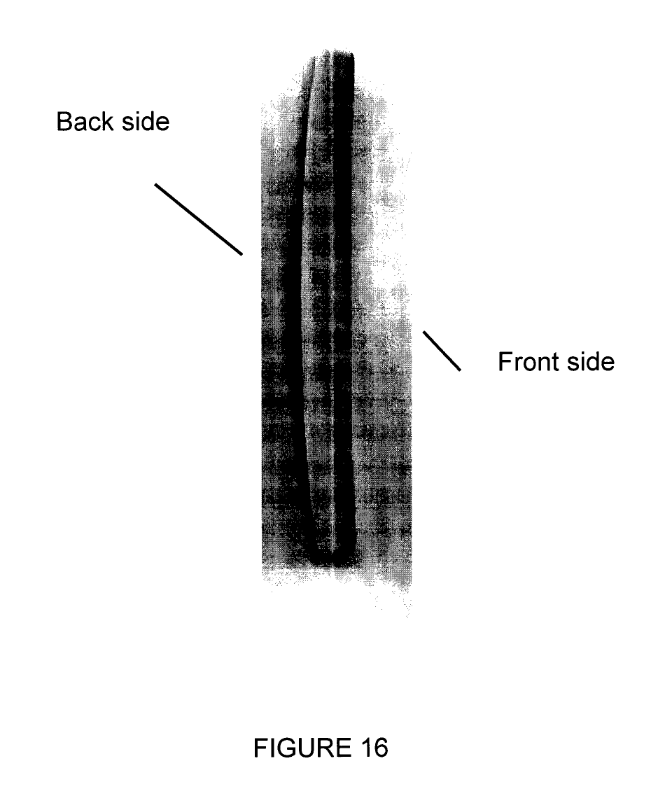

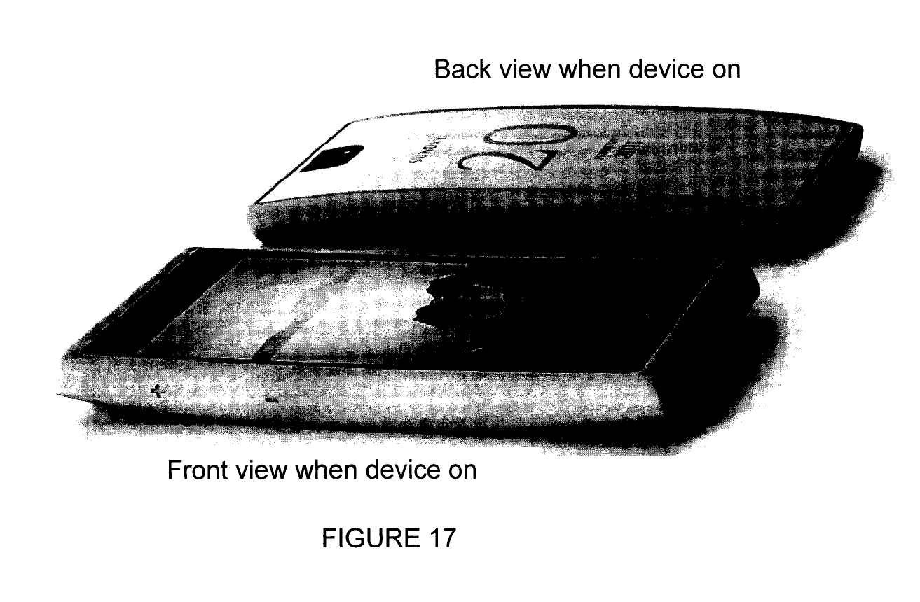

The electrical connector composite may be provided built-in to a mobile device. The mobile device may be a mobile phone, a laptop computer, a tablet computer (eg. ipad), a portable digital assistant, a digital audio player (eg. ipod), an iPhone, an iPad, or a bar form factor portable device. Bar form factors include slab, slate, block, bar and candybar. The bar form factor display device may comprise front and back major faces, the front major face arranged to present a first display screen and the back major face arranged to present a second display screen different to the first display screen. The bar form factor display device may be one in which the second display screen is a bi-stable display screen. The bar form factor display device may be one in which the first display screen is a liquid crystal display screen. The bar form factor display device may be one in which the device includes a concave front face and a convex rear face. FIGS. 14 to 17 provide examples of bar form factor display devices in which the electrical connector composite may be provided built-in.

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred example(s) of the invention, it will be apparent to those of ordinary skill in the art that numerous modifications can be made without departing from the principles and concepts of the invention as set forth herein.

Appendix 1—Universal Serial Bus (USB) Technology Primer

A USB system has an asymmetric design, consisting of a host, a multitude of downstream USB ports, and multiple peripheral devices connected in a tiered-star topology. Additional USB hubs may be included in the tiers, allowing branching into a tree structure with up to five tier levels. A USB host may have multiple host controllers and each host controller may provide one or more USB ports. Up to 127 devices, including hub devices if present, may be connected to a single host controller.

USB devices are linked in series through hubs. There always exists one hub known as the root hub, which is built into the host controller. So-called sharing hubs, which allow multiple computers to access the same peripheral device(s), also exist and work by switching access between PCs, either automatically or manually. Sharing hubs are popular in small-office environments. In network terms, they converge rather than diverge branches.

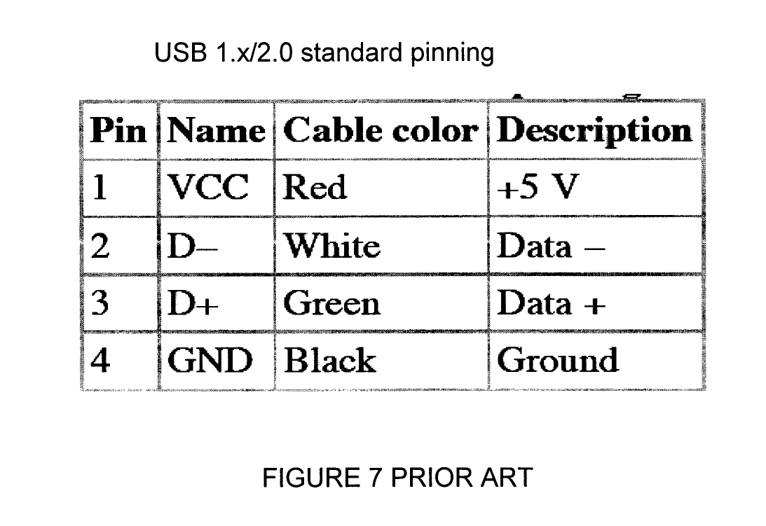

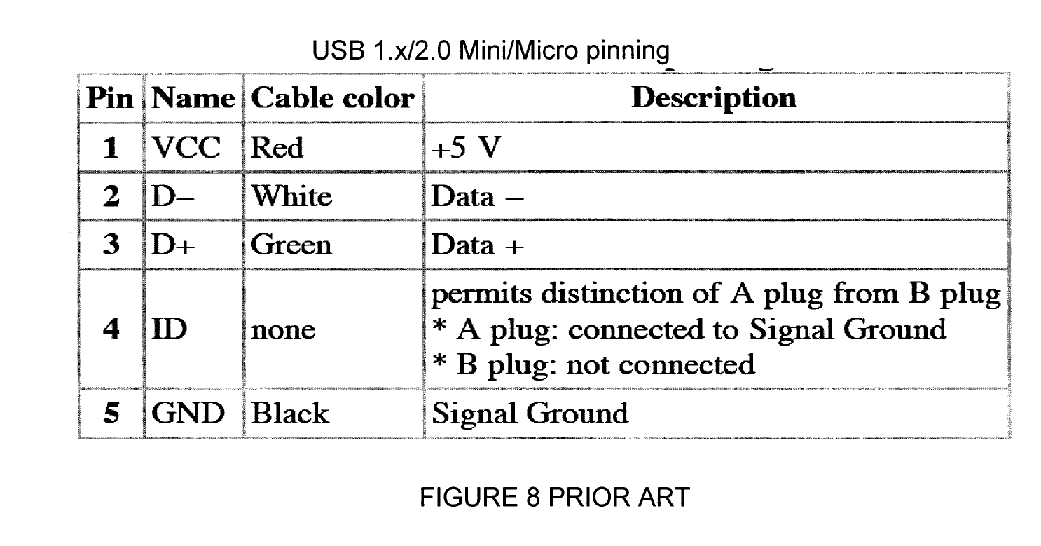

USB 1.x/2.0 standard pinning is shown in prior art FIG. 7. USB 1.x/2.0 Mini/Micro pinning is shown in prior art FIG. 8.

The standard USB connectors were deliberately intended to enforce the directed topology of a USB network: type A connectors on host devices that supply power and type B connectors on target devices that receive power. This prevents users from accidentally connecting two USB power supplies to each other, which could lead to dangerously high currents, circuit failures, or even fire. USB does not support cyclical networks and the standard connectors from incompatible USB devices are themselves incompatible. Unlike other communications systems (e.g. RJ-45 cabling) gender changers make little sense with USB and are almost never used.

The newer Micro-USB receptacles are designed to allow up to 10,000 cycles of insertion and removal between the receptacle and plug, compared to 1,500 for the standard USB and 5,000 for the Mini-USB receptacle. This is accomplished by adding a locking device and by moving the leaf-spring connector from the jack to the plug, so that the most-stressed part is on the cable side of the connection. This change was made so that the connector on the less expensive cable would bear the most wear instead of the more expensive micro-USB device.

The USB standard specifies relatively loose tolerances for compliant USB connectors, in order to minimize physical incompatibilities in connectors produced by different vendors. To address a weakness present in some other connector standards, the USB specification also defines limits to the size of a connecting device in the area around its plug. This was done to prevent a device from blocking adjacent ports due to the size of the cable strain relief mechanism (usually molding integral with the cable outer insulation) at the connector. Compliant devices must either fit within the size restrictions or support a compliant extension cable which does.

Two-way communication is also possible. In USB 3.0, full-duplex communications are done when using SuperSpeed (USB 3.0) transfer. In previous USB versions (i.e., 1.x or 2.0), all communication is half-duplex and directionally controlled by the host.

In general, cables have only plugs (very few have a receptacle on one end), and hosts and devices have only receptacles. Hosts almost universally have type-A receptacles, and devices one or another type-B variety. Type-A plugs mate only with type-A receptacles, and type-B with type-B; they are deliberately physically incompatible. However, an extension to USB standard specification called USB On-The-Go allows a single port to act as either a host or a device—chosen by which end of the cable plugs into the receptacle on the unit. Even after the cable is hooked up and the units are talking, the two units may “swap” ends under program control. This capability is meant for units such as PDAs in which the USB link might connect to a PC's host port as a device in one instance, yet connect as a host itself to a keyboard and mouse device in another instance.

USB 3.0 receptacles are electrically compatible with USB 2.0 device plugs if they can physically match. Most combinations will work, but there are a few physical incompatibilities. However, only USB 3.0 Standard-A receptacles can accept USB 3.0 Standard-A device plugs.

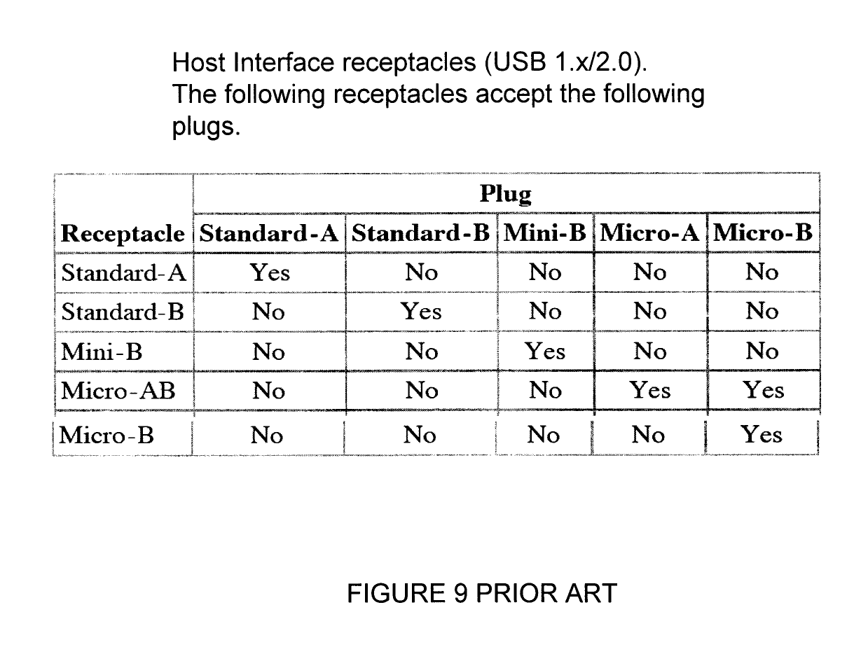

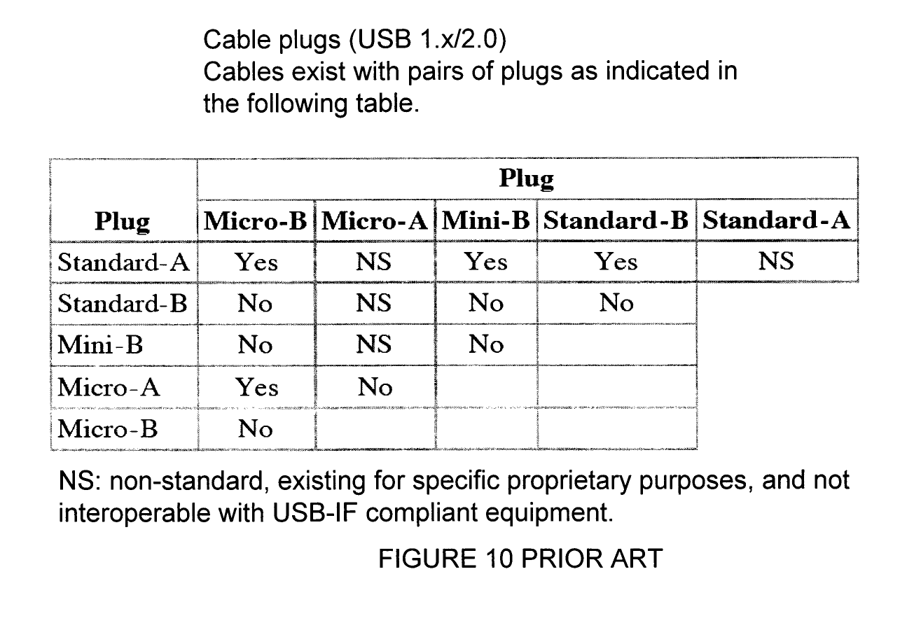

Host Interface receptacles (USB 1.x/2.0) information is shown in prior art FIG. 9. Cable plugs (USB 1.x/2.0) information is shown in prior art FIG. 10.

USB Standard Connectors

Standard Type A

The Standard-A type of USB plug is a flattened rectangle which inserts into a “downstream-port” receptacle on the USB host, or a hub, and carries both power and data. This plug is frequently seen on cables that are permanently attached to a device, such as one connecting a keyboard or mouse to the computer via USB connection.

USB connections eventually wear out as the connection loosens through repeated plugging and unplugging. The lifetime of a USB-A male connector is approximately 1,500 connect/disconnect cycles. There are female-female connectors.

An adapter comprising a Standard-B receptacle and a Standard-A receptacle is used to connect two cables

Standard Type B

A Standard-B plug—which has a square shape with bevelled exterior corners—typically plugs into an “upstream receptacle” on a device that uses a removable cable, e.g. a printer. A Type B plug delivers power in addition to carrying data. On some devices, the Type B receptacle has no data connections, being used solely for accepting power from the upstream device. This two-connector-type scheme (A/B) prevents a user from accidentally creating an electrical loop.

USB Mini and Micro Connectors

Various connectors have been used for smaller devices such as PDAs, mobile phones or digital cameras. These include the now-deprecated (but standardized) Mini-A and the currently standard Mini-B, Micro-A, and Micro-B connectors. The Mini-A and Mini-B plugs are approximately 3 mm by 7 mm.

The micro-USB plugs have a similar width but approximately half the thickness, enabling their integration into thinner portable devices. The micro-A connector is 6.85 mm by 1.8 mm with a maximum overmold size of 11.7 mm by 8.5 mm. The micro-B connector is 6.85 mm by 1.8 mm with a maximum overmold size of 10.6 mm by 8.5 mm. Mini-USB is often used by digital camcorders.

The Micro-USB connector was announced by the USB-IF on Jan. 4, 2007 and the Mini-A and Mini-B USB connectors were deprecated at the same time. As of February 2009, many currently available devices and cables still use Mini plugs, but the newer Micro connectors are being widely adopted. The thinner micro connectors are intended to replace the Mini plugs in new devices including smartphones and personal digital assistants. The Micro plug design is rated for at least 10,000 connect-disconnect cycles which is significantly more than the Mini plug design. The Universal Serial Bus Micro-USB Cables and Connectors Specification details the mechanical characteristics of Micro-A plugs, Micro-A receptacles, and Micro-B plugs and receptacles, along with a Standard-A receptacle to Micro-A plug adapter.

The cellular phone carrier group, Open Mobile Terminal Platform (OMTP), have recently endorsed Micro-USB as the standard connector for data and power on mobile devices. These include various types of battery chargers, allowing Micro-USB to be the single external cable link needed by some devices. As of Jan. 30, 2009 Micro-USB has been accepted by almost all cell phone manufacturers as the standard charging port (including HTC, Motorola, Nokia, LG, Hewlett-Packard, Samsung, Sony Ericsson, Research In Motion) in the EU and most of the world. Worldwide conversion to the new cellphone charging standard is expected to be completed between 2010 to 2012.

In addition, on 22 Oct. 2009 the International Telecommunication Union (ITU) announced that it had embraced micro-USB as the Universal Charger Solution its “energy-efficient one-charger-fits-all new mobile phone solution”, and added: “Based on the Micro-USB interface, UCS chargers will also include a 4-star or higher efficiency rating—up to three times more energy-efficient than an unrated charger.”

USB Micro-A or B Socket On-The-Go (OTG)

An OTG device is required to have one, and only one USB connector: a Micro-A or B receptacle as defined in [Micro-USB1.01]. This receptacle is capable of accepting either a Micro-A plug or a Micro-B plug attached to any of the legal cables and adapters defined in [Micro-USB1.01].

The OTG device with the A-plug inserted is called the A-device and is responsible for powering the USB interface when required and by default assumes the role of host. The OTG device with the B-plug inserted is called the B-device and by default assumes the role of peripheral. An OTG device with no plug inserted defaults to acting as a B-device. If an application on the B-device requires the role of host, then the HNP protocol is used to temporarily transfer the host role to the B-device.

OTG devices attached either to a peripheral-only B-device or a standard/embedded host will have their role fixed by the cable since in these scenarios it is only possible to attach the cable one way around.

1. Electrical connector composite comprising a first electrical connector and a second electrical connector, the electrical connector composite mountable in a device and providing an electrical connection to the device, the electrical connector composite rotatable with respect to the device when mounted in the device, the electrical connector composite rotatable to present the first electrical connector in an electrically connectable configuration, and the electrical connector composite rotatable to present the second electrical connector in an electrically connectable configuration.

2. Electrical connector composite of claim 1, wherein the electrical connector composite is built into the device.

3. Electrical connector composite of any previous claim 1, wherein leads from the first electrical connector are electrically connected to leads in common from the second electrical connector.

4. Electrical connector composite of any previous claim 1, wherein the electrical connector composite includes a flexible material.

5. Electrical connector composite of claim 4, wherein the flexible material is fully self-supporting or partially self-supporting.

6. (canceled)

7. Electrical connector composite of claim 1, wherein the electrical connector composite includes a flexible portion situated between the first electrical connector and the second electrical connector.

8. Electrical connector composite of claim 1, wherein the electrical connector composite is substantially composed of flexible material.

9. Electrical connector composite of claim 1, wherein the first electrical connector is substantially composed of flexible material.

10. Electrical connector composite of claim 1, wherein the second electrical connector is substantially composed of flexible material.

11-12. (canceled)

13. Electrical connector composite of claim 1, wherein the first electrical connector and the second electrical connector have a relative orientation of 180 degrees within the electrical connector composite.

14. Electrical connector composite of claim 1, wherein the first electrical connector and the second electrical connector are respectively presented for electrical connection upon rotation of the electrical connector composite by 180 degrees.

15. Electrical connector composite of claim 1, wherein the first electrical connector and the second electrical connector are situated on opposite sides of the electrical connector composite.

16. Electrical connector composite of claim 1, wherein the first electrical connector and the second electrical connector have a relative orientation of 90 degrees within the electrical connector composite.

17. Electrical connector composite of claim 1, wherein when the second electrical connector is presented for electrical connection, the first electrical connector adopts a general profile of the device.

18-19. (canceled)

20. Electrical connector composite of claim 1, wherein the electrical connector composite is in swivelling attachment with the device.

21. Electrical connector composite of claim 1, wherein one or both of the first electrical connector and the second electrical connector is a USB connector.

22. (canceled)

23. Electrical connector composite of claim 21, wherein the first electrical connector and the second electrical connector are differing USB connectors.

24. Electrical connector composite of claim 23, wherein the first electrical connector is a male connector and the second electrical connector is a female connector.

25-27. (canceled)

28. Electrical connector composite of claim 21, wherein the electrical connector composite can be rotated to present one USB connector or the other USB connector, for a user to plug into.

29. Device into which the electrical connector composite of claim 1 is built in.

30. Device of claim 29, wherein the device is a mobile device.

31-37. (canceled)
